(19) United States
(12) Patent Application Publication
(10) Pub. No.: US 2008/0145609 A1
(43) Pub. Date: Jun. 19, 2008

(54) Anti-glare optical plate and manufacturing method and manufacturing device

(76) Inventors: Charles Lin, Jhongli City (TW); Jen-Huai Chang, Jhongli City (TW); Jyh-Horng Wang, Jhongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/730,936

(22) Filed: Apr. 5, 2007

(30) Foreign Application Priority Data
Dec. 19, 2006 (TW) 095147724

(51) Int. Cl. B32B 17/10

(52) U.S. Cl. 428/141; 264/1.1; 264/2.6; 425/470; 118/258; 427/162

(57) ABSTRACT

An anti-glare optical plate is disclosed. A mold with a concave-convex surface is disposed with a resin on top and a substrate is arranged over the resin. After the resin hardening to form a film on the substrate, the film has a concave-convex surface on top thereof so as to make light scatter by the concave-convex structure on top of the film for preventing uncomfortable feelings of users due to reflection of light.

### BACKGROUND OF THE INVENTION

The present invention relates to an optical plate, a manufacturing device, and a manufacturing method thereof, especially to an anti-glare optical plate, a manufacturing device and a manufacturing method thereof.

Along with popularity of notebooks, liquid crystal displays, rear projection television and mobile phones, image quality of the display becomes more important. For users, it's a point to choose monitors that reduces uncomfortable feeling after watching for a long period of time. Thus every manufacture is trying to improve their products in such respect.

Generally, monitors are disposed with a protector with certain hardness for preventing scratches. Some protection plates have other special function can be sold with higher prices. Therefore, the protection plate may be combined with an optical film such as anti-glare film, anti-static electricity film, anti-fingerprint film and Anti-reflection film so as to increases functions of the protection plate.

The way to coat multi-layer optical film is by wet coating technology such as dip coating, spin coating, roll coating, spray coating, curtain coating, extrusion coating and so on.

Refer to FIG. 1, the optical film 10 made by conventional technology includes a resin 12 composed of a plurality of particles 14. When light from surrounding areas emits on the film 10, it will be reflected irregularly by surfaces of the particles 14 so as to have scattering effect. Thus light is not going to be reflected to enter users eyes directly. Therefore, the film 10 is disposed on the protector by coating method so as to make the surface foggy and roughening for scattering the reflected light and protecting users eyes.

The plurality of particles 14 is coated on surface of the protector through the resin 12 by dip coating or spray coating. The way to dispose particles may lead to reduced transparency and further cause reduction of resolution and definition. Conventional coating technology also has its disadvantages. For example, in dip coating process, the protector is pulled out at certain speed from the paints. Besides precipitate of the particles 14 inside the paints, this method is not suitable for large-size protector because the thickness of the film 10 on upper and lower areas of the protector may be different and this cause various scattering quality. As to the spay coating, only 30 percent of the paints coats on the protector while the rest 70 percent is wasted. Thus the cost of paints in increased.

Thus there is a need to provide an anti-glare optical plate, a manufacturing device, and a manufacturing method thereof that not only increase product stability but also reduce the manufacturing cost.

### SUMMARY OF THE INVENTION

Therefore it is a primary object of the present invention to provide an anti-glare optical plate, a manufacturing device and a manufacturing method thereof. By concave-convex design of a film, light is scattered so as to protect users from reflected light.

A mold with concave-convex design includes continuous curved surfaces or spherical surfaces whose radius of curvature ranges from 0.05 um to 5 um, from 0.1 um to 3 um is preferably and from 0.2 um to 1.5 um is the best. The surface roughness (Ra) ranges from 0.01 um to 5 um, from 0.05 um to 1 um is preferably while from 0.1 um to 0.5 um is the best. Such design has excellent scattering effect of the reflected light while still keeps transmittance over 93% with reduced blinking dots. Thus users won't feel uncomfortable caused by the blinking dots. The mold with concave-convex structure is made by mechanical processing, chemical etching, laser processing, electrical discharge machining or electroforming and so on.

It is another object of the present invention to provide an anti-glare optical plate, a manufacturing device and a manufacturing method thereof. By a mold with a concave-convex surface, a film is formed with a concave-convex surface so as to improve quality of the optical plate. Moreover, there is no need to use particles that may reduce transmittance and further cause reduction of the resolution and definition. The manufacturing cost of the optical plate is also reduced.

An anti-glare optical plate according to the present invention consists of a substrate and a film. The film with concave-convex surface is disposed on top of the substrate. Light is scattered by the concave-convex surface of the film so as to avoid negative effect on the user caused by reflection.

A manufacturing device of an anti-glare optical plate according to the present invention consists of a mold, a resin and a substrate. The surface of the mold is concave-convex. The resin is disposed on top of the mold while the substrate is arranged on top of the resin so that the resin forms a film with concave-convex surface over the substrate.

A manufacturing method of an anti-glare optical plate according to the present invention includes following steps: firstly, provide a mold. A resin is set on top of the mold and then a substrate is disposed on top of the resin so as to make the resin form a film with concave-convex surface on the substrate.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic drawing showing a high-hardness anti-glare optical plate made by conventional technique;

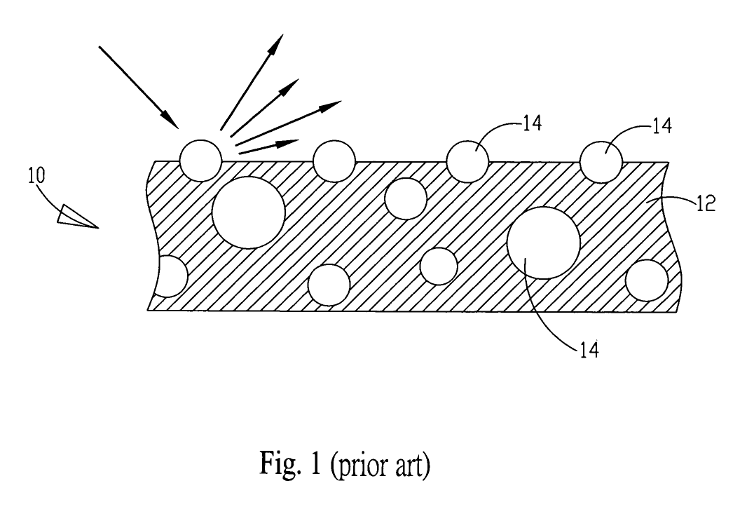

FIG. 2 is a schematic drawing showing an embodiment of an anti-glare optical plate according to the present invention;

FIG. 3 is a schematic drawing showing a manufacturing device of an anti-glare optical plate

FIG. 4 is a flow chart of an embodiment according to the present invention;

FIG. 5 is a flow chart of another preferred embodiment according to the present invention.

### DETAILED DESCRIPTION OF THE PREFERRED EMBODIMENT

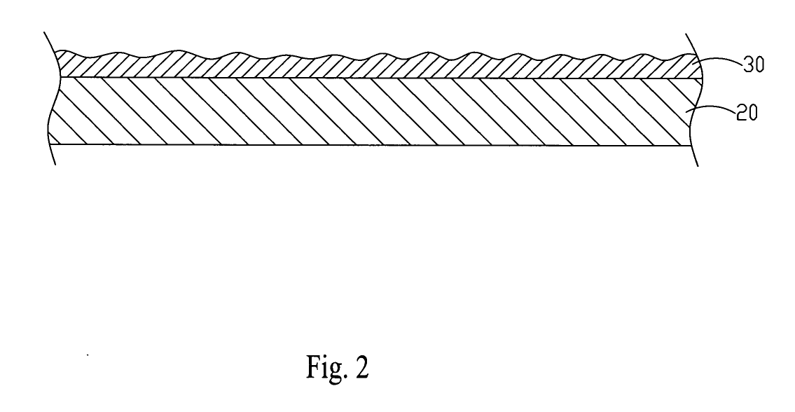

Refer to FIG. 2, an anti-glare optical plate is composed of a substrate 20 and a film 30. The film 30 with irregular surface on top thereof is disposed on top of the substrate 20. The irregular surface can be irregular concave-convex surface or regular concave-convex surface. In the present invention, a concave-convex surface is taking as an embodiment.

The substrate 20 is made from acrylic while the film 30 is made from resin. Materials for the substrate 20 and the film 30 can be changed according to users needs. The resin material includes UV(ultraviolet) curing resin.

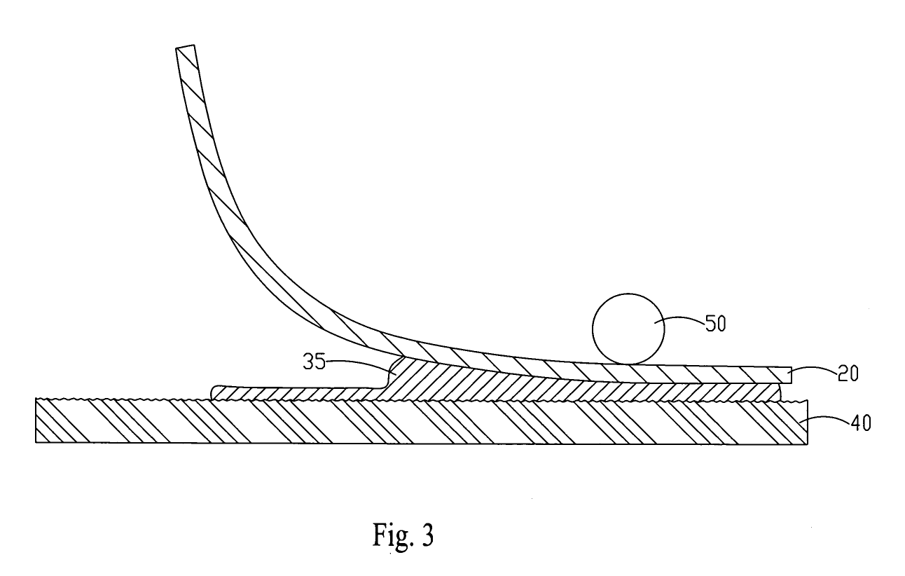

Refer to FIG. 3, a manufacturing device of an anti-glare optical plate according to the present invention consists of a mold 40, a resin 35 and a substrate 20. Top surface of the mold 40 is concave-convex. The resin 35 is disposed on top of the mold 40 while the substrate 20 is arranged on top of the resin 35 so that the resin 35 forms a film 30 with concave-convex surface on the substrate 20.

The concave-convex surface of the mold 40 is formed by continuous curved surfaces or spherical surfaces whose radius of curvature ranges from 0.05 um to 5 um, from 0.1 um to 3 um is preferably and from 0.2 um to 1.5 um is the best so as to provide excellent scattering effect of the reflected light while still keeps transmittance over 93% with reduced blinking dots. Thus users won't feel uncomfortable caused by the blinking dots. If the surface of the mold 40 is with concave-convex structure, the surface roughness (Ra) ranges from 0.01 um to 5 um, from 0.05 um to 1 um is preferably while from 0.1 um to 0.5 um is the best so as to provide excellent scattering effect of the reflected light while still keeps transmittance over 93% with reduced blinking dots. Thus users won't feel uncomfortable caused by the blinking dots. The concave-convex design of the mold 40 is made by mechanical processing, chemical itching, laser processing, electrical discharge machining or electroforming processes and so on.

After the resin 35 being disposed on top surface of the mold 40, a substrate 20 made from acrylic with thickness of 2 to 3 cm is slowly covered over the resin 35. The resin 35 is UV curing resin. In order to make the resin 35 distribute homogeneously between the substrate 20 and the mold 40, the manufacturing device of the anti-glare optical plate according to the present invention further includes a roller 50. The roller 50 rolls over the substrate 20. While the roller 50 rolling on the substrate 20, the resin 35 is spread out effectively along with the rolling direction of the roller 50. At the same time, bubbles generated by disposition of the resin 35 on the mold 40 are also removed. For eliminating more bubbles, the viscosity of the resin 35 is ranging from 200 Cp to 600 Cp. Moreover, the resin 35 further includes defoaming agent that reduces bubbles. The defoaming agent ranged from 0.1% to 1% weig ht percent of the resin 35.

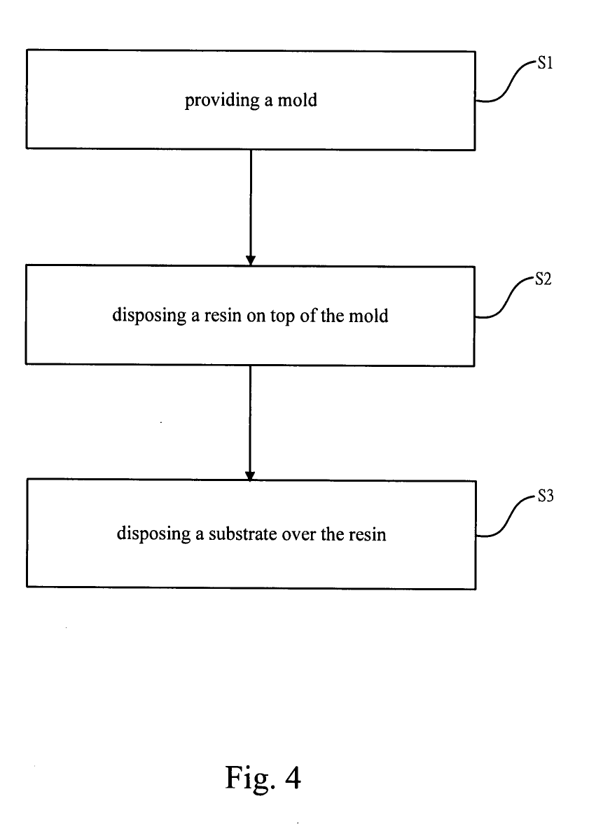

Refer to FIG. 4, a manufacturing method of anti-glare optical plates according to the present invention includes the steps in the figure. Refer to the step S1, provide a mold 40. Then run the step S2, dispose a resin 35 on top of the mold 40. Take the step S3, disposed a substrate 20 over the resin 35 so that a film 30 is formed on the substrate 20 after the resin 35 hardening. The top surface of the film 30 is concave-convex, as shown in FIG. 2.

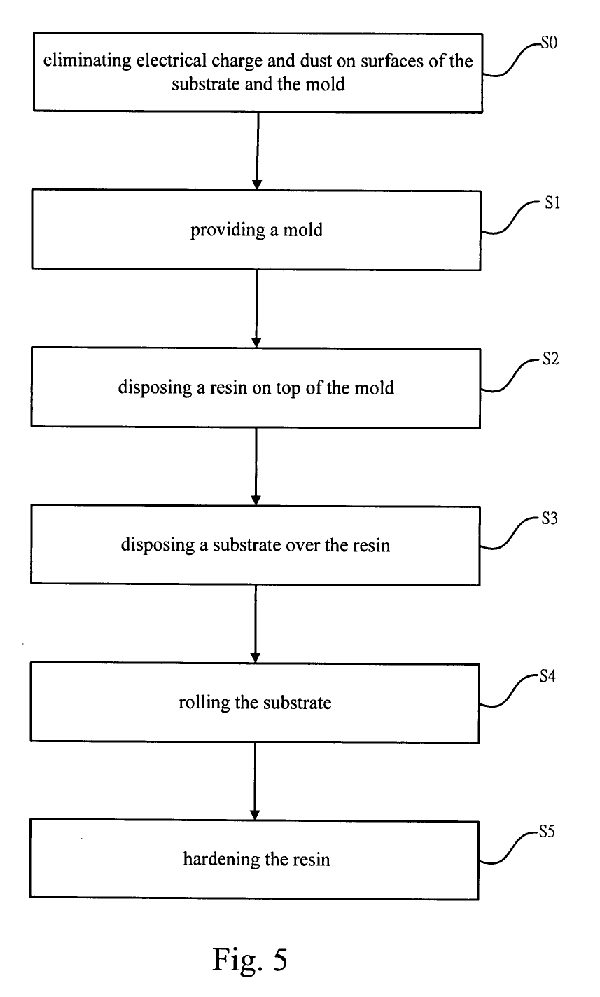

Refer to FIG. 5, the difference between this embodiment and above one is in that before the step S1, a step S0 is further included. The step S0 is to eliminate electrical charge and dust on surfaces of the substrate 20 and the mold 40. In order to achieve this, a static eliminator is sued to neutralize static electricity and remove dust or particles caused by static electricity on surface of the substrate 20 and the mold 40.

For homogeneously distribution of the resin 30 between the mold 40 and the substrate 20, run the step S4, roll the substrate 20. Furthermore, in order to accelerate hardening of the resin 35 that includes UV curing resin, take the step S5, the substrate 20, the resin 35 and the mold 40 together with the belt conveyer are lighted by a UV lamp so as to make the resin 35 cure after the substrate 20 covered over the resin 35. After the resin 35 hardening, the film 30 formed by the resin 35 with the substrate is separated from the mold 40 and the separated mold 40 is sent back to the static eliminator by the belt conveyor for removing electrical charge.

In summary, provide a mold with concave-convex surface. Then a resin is disposed on top of the mold and a substrate is arranged over the resin so that the resin forms a film with concave-convex surface on the substrate. Thus light is scattered by the concave-convex design on top of the film so as to avoid uncomfortable feelings of users due to reflection caused by the optical plate.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An anti-glare optical plate comprising
a substrate; and
a film having an irregular surface on top thereof being disposed on top of the substrate.

2. The anti-glare optical plate as claimed in claim 1, wherein the irregular surface can be irregular concave-convex surface or regular concave-convex surface.

3. The anti-glare optical plate as claimed in claim 1, wherein the substrate is made from acrylic.

4. The anti-glare optical plate as claimed in claim 1, wherein the film is made from resin.

5. The anti-glare optical plate as claimed in claim 4, wherein the resin having ultraviolet curing resin.

6. A manufacturing device of an anti-glare optical plate comprising:
a mold having concave-convex surface on top;
a resin disposed on top of the mold; and
a substrate arranged on top of the resin.

7. The manufacturing device as claimed in claim 6, wherein the substrate is made from acrylic.

8. The manufacturing device as claimed in claim 6, wherein the resin having ultraviolet curing resin.

9. The manufacturing device as claimed in claim 6, wherein the resin further having defoaming agent.

10. The manufacturing device as claimed in claim 6, wherein the manufacturing device further comprising a roller rolling over the substrate.

11. The manufacturing device as claimed in claim 6, wherein the concave-convex surface on top of the mold comprising continuous curved surfaces or spherical surfaces whose radius of curvature ranges from 0.05 um to 5 um.

12. The manufacturing device as claimed in claim 6, wherein surface roughness (Ra) of the concave-convex surface on top of the mold ranges from 0.01 um to 5 um.

13. The manufacturing device as claimed in claim 6, wherein the concave-convex surface on top of the mold is made by mechanical processing, chemical itching, laser processing, electrical discharge machining or electroforming process.

14. A manufacturing method of an anti-glare optical plate comprising the steps of:
providing a mold;
disposing a resin on top of the mold; and
arranging a substrate over the resin.

15. The manufacturing method as claimed in claim 14, wherein before the step of providing a mold, the method further comprising a step of:
removing static electricity, dust and particles on the mold and the substrate.

16. The manufacturing method as claimed in claim 14, wherein after the step of arranging a substrate over the resin, the method further comprising a step of: rolling the substrate.

17. The manufacturing method as claimed in claim 14, wherein after the step of arranging a substrate over the resin, the method further comprising a step of: hardening the resin.
